(19) United States
(12) Patent Application Publication
(10) Pub. No.: US 2013/0316059 A1
(43) Pub. Date: Nov. 28, 2013

(54) PLIABLE SUPPORT FOR A FOOD PRODUCT OR PREPARATION IN A ROASTING PAN

(71) Applicants: Dean B. CHAPMAN, New York, NY (US); Edward KILDUFF, New York, NY (US); Sung N. TRUONG, Brooklyn, NY (US)

(72) Inventors: Dean B. CHAPMAN, New York, NY (US); Edward KILDUFF, New York, NY (US); Sung N. TRUONG, Brooklyn, NY (US)

(21) Appl. No.: 13/890,232

(22) Filed: May 8, 2013

Related U.S. Application Data
(63) Continuation-in-part of application No. 13/633,617, filed on Oct. 2, 2012.
(60) Provisional application No. 61/601,543, filed on Feb. 21, 2012.

(51) Int. Cl. A47J 36/34

(52) U.S. Cl. CPC A47J 36/34
USPC 426/523; 99/444

(57) ABSTRACT

A support for providing a stable resting place for a food product being cooked in a roasting pan. The support has a pliable spine and a plurality of heat resistant elements that extend outwardly from the spine. In one embodiment the spine has a core member, such as a wire, that enables it to be manipulated by a user into a variety of shapes so as to be adaptable to support foods having different shapes and sizes. The spine and heat resistant elements can be molded of silicone with the core member molded therewithin. In another embodiment, the core member is not present, and the support is assembled into stable conformations by the releasable engagement of heat resistant elements with each other. The heat resistant elements may be formed in a variety of shapes, including regularly spaced and paired T-shaped projections. Alternately, the heat resistant elements may be molded into various decorative shapes such as leaves, and as illustrated in one embodiment herein, gives the appearance of a laurel.

### RELATED APPLICATIONS

The present application is a Continuation-In-Part of co-pending non-provisional application Ser. No. 13/633,617, filed Oct. 2, 2012, which in turn, claims the benefit under 35 U.S.C. §119 of U.S. Provisional Application Ser. No. 61/601,543 filed Feb. 21, 2012. The contents of said provisional application and said non-provisional application are hereby incorporated by reference in their entireties.

### BACKGROUND

The present invention relates to a device for supporting the position of a food product or preparation as it is roasted, and, more particularly, to a pliable, elongated support that can be manipulated into a variety of configurations to retain and support a food product during the roasting thereof.

It is certainly common to roast various foods, and particularly, meats such as beef, chicken and turkey and the like, in roasting pans. During the roasting process, however, it is desirable to elevate the food away from contact with the bottom of the roasting pan, as this would avoid permitting the food to sit and cook in the liquid fat and burned bits of food that accumulate at the bottom of the roasting pan. In addition, the separation of the food from the bottom of the roasting pan facilitates more even cooking of the entire portion of food being prepared, as the heat can more uniformly reach the full exterior surface of the portion.

It is known that flat racks are used to raise food being heated, away from the bottom of a roasting pan. However, a difficulty with the use of the racks is that the various foods to be roasted are of differing configurations and sizes such that the food may not sit firmly on the flat surface of a rack. In addition, the use of racks and the like also makes the uniform heating of the food difficult, as the racks contact a relatively large surface of the food being roasted and, again, the heat is not distributed evenly around the roasting food.

The racks can also be difficult to handle, and a rack for one roasting pan may not fit into a differently sized roasting pan, so that multiple racks are often required for multiple roasting pans.

It would therefore be advantageous to have a support that could be placed in the bottom of a roasting pan to elevate the food away from the bottom of the roasting pan and which could be shaped according to the configuration and size of the particular food being roasted in the roasting pan, as well as the size and shape of the pan.

It would also be advantageous to have a low cost support that would retain foods of different shapes and sizes in a stable orientation with a minimum of actual contact with the food being roasted in the roasting pan, and that would be usable with roasting pans of differing size.

### SUMMARY OF THE INVENTION

Accordingly, the present invention relates to a versatile food support that can be used to suspend and retain, in a stable manner, a food product or preparation as it is being heated in an oven (roasted), and is disposed in a roasting pan. The support is adaptable, and is capable of configuration in a variety of shapes and conformations. The present support can be manipulated into a particular desired shape, so as to be best suited for the suspension and retention of the shape and size of the food product being roasted. Likewise, the support is capable of manipulation to accommodate both food products of differing shapes and sizes, as well as differently sized roasting pans.

The support has an elongated pliable spine that has a plurality of spaced apart heat resistant elements or projections extending outwardly therefrom. The spine and heat resistant elements or projections are preferable molded from a material that is heat resistant, such as silicone. In a particular exemplary aspect, the heat resistant material may be a resin, and particularly a food-grade silicone resin.

The support may be wholly molded from the pliable, heat resistant material as described above, or may in one embodiment, contain a core member, such as a wire, that is molded into the spine. The core member is also bendable, so that the resulting support can be manipulated into a wide variety of desired configurations by the user depending upon the size and shape of the food to be roasted. Once formed, the support will stably retain the desired configuration.

The heat resistant elements or projections may assume a variety of shapes, including the ‘leaves’ of a ‘laurel’, as depicted in FIGS. 1-10, and the projections that may be generally T-shaped, as depicted in FIGS. 13-41. In the embodiments illustrated in FIGS. 33-41, the projections are capable of releasable engagement and thereby function to secure the support in a particular configuration to provide a stable surface for the elevated support of a food item to be cooked. This same capability may be demonstrated by the projections depicted in FIGS. 1-12, when the projections are placed adjacent each other and positioned into interleaved engagement therewith, or as illustrated and discussed with respect to FIG. 10 and FIGS. 39 and 40, later on herein.

Accordingly, by means such as the interlocking engagement of the projections or the configuration of the embodiment of the support containing the core member, the support can be manipulated into a particular shape that is stable and is supportive of a certain size and shape of the food. The support can then be placed in the bottom of a roasting pan, and the food positioned atop of and retained by the support in a stable manner such that the food is elevated and out of contact with the bottom of the roasting pan to prevent it from sitting in any fat and burned bits of food, that may be formed or result from the roasting process.

These and other features and advantages of the present invention will become more readily apparent during the following detailed description taken in conjunction with the drawings herein.

### BRIEF DESCRIPTION OF THE DRAWINGS

FIG. 1 is a top view of a support constructed in accordance with one embodiment of the present invention;

FIG. 2 is a side view of the support of FIG. 1;

FIG. 3 is a bottom view of the support of FIG. 1;

FIG. 4 is an end view of the support of FIG. 1;

FIG. 5 is a cross sectional, perspective view of the support of FIG. 1;

FIG. 6 is a perspective view of the support of FIG. 1;

FIG. 7 is a perspective view of the support of FIG. 1 manipulated into a U-shape configuration;

FIG. 8 is a is a perspective view of the support of FIG. 1 manipulated into a circular configuration;

FIG. 9 is a perspective view of the support of FIG. 1 manipulated into an S-shaped configuration;

FIG. 10 is a perspective view of a support of FIG. 1 manipulated such that a distal end of the support is attached to itself along the length thereof;

FIG. 11 is a perspective view illustrating the manual manipulation of the support of the present invention to form a desired configuration; and

FIG. 12 is a perspective view, partially cut away, showing the support of the present invention contained within a roasting pan and supporting a food for roasting.

FIG. 13 is a perspective view of a support in accordance with a first alternate embodiment of the invention.

FIG. 14 is a side view of the embodiment of FIG. 13.

FIG. 15 is a bottom view thereof.

FIG. 16 is a top view thereof.

FIG. 17 is an end view thereof.

FIG. 18 is a perspective view like FIG. 13, of a second alternate embodiment of the support of the invention.

FIG. 19 is a bottom view of the support of FIG. 18.

FIG. 20 is a side view thereof.

FIG. 21 is a top view thereof.

FIG. 22 is an end view thereof.

FIG. 23 is a perspective view like FIG. 18, of a third alternate embodiment of the support of the invention.

FIG. 24 is a side view thereof.

FIG. 25 is a bottom view thereof.

FIG. 26 is a top view thereof.

FIG. 27 is an end view thereof.

FIG. 28 is a perspective view like FIG. 23, of a fourth alternate embodiment of the support of the invention.

FIG. 29 is a side view thereof.

FIG. 30 is a bottom view thereof.

FIG. 31 is a top view thereof.

FIG. 32 is an end view thereof.

FIG. 33 is a bottom view showing the support of FIG. 18 configured in a ‘teardrop’ shape with adjacent elements in releasable engagement with each other.

FIG. 34 is a perspective view of the support depicted in FIG. 33.

FIG. 35 is a bottom view like that of FIG. 33, showing the support of FIG. 23 in the same configuration and engagement.

FIG. 36 is a perspective view like that of FIG. 34 showing the support of FIG. 23 in the same configuration.

FIG. 37 is a bottom view like that of FIG. 35, showing the support of FIG. 28 in the same configuration and engagement.

FIG. 38 is a perspective view like that of FIG. 36 as to the support of FIG. 28.

FIGS. 39 and 40 show the assembly of the support of FIG. 13 into a circular configuration, including the connection of adjacent elements to each other; and

FIG. 41 is a perspective view like that of FIG. 12, partially cut away, showing the support of FIG. 13 contained within a roasting pan and supporting a food for roasting

### DETAILED DESCRIPTION OF THE INVENTION

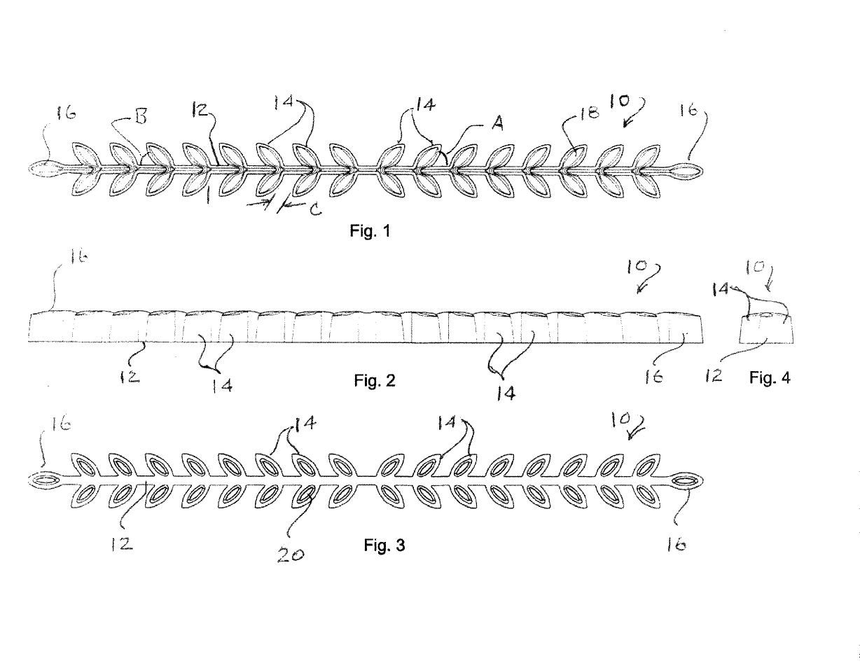

Referring now to all of the figures wherein like parts are described and are to be designated with like or comparable element numbers, and particularly commencing with FIGS. 1-4, there are shown a top view, side view, bottom view and an end view, respectively, of a support 10 that is used to suspend and retain a food product in a stable manner during the roasting thereof. As can be seen, the support 10 comprises an elongated spine 12 that extends substantially the full length of the support 10. The elongated spine 12 is comprised of a pliable material and, in the exemplary embodiment, the material is a heat resistant material such as silicone that is sufficiently heat resistant to enable the support 10 to be resident in a heated oven for a period of time to carry out the cooking of a food. In particular, the pliable material may be a synthetic resin, and more particularly, may be a food grade formulation, such as a suitable silicone.

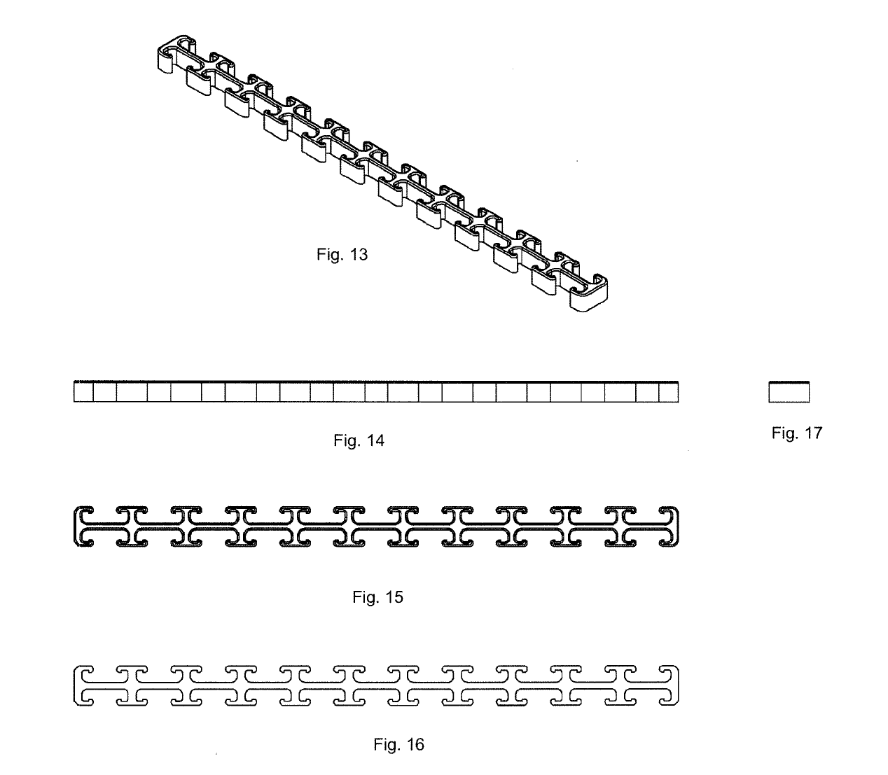

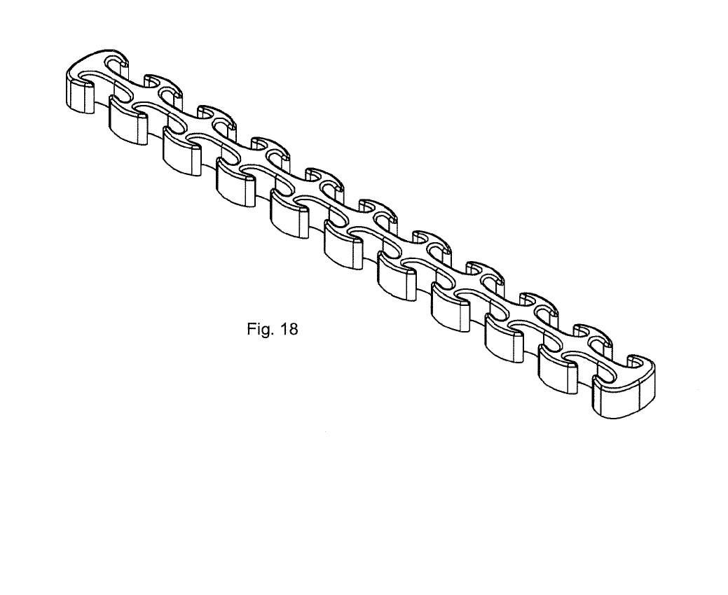

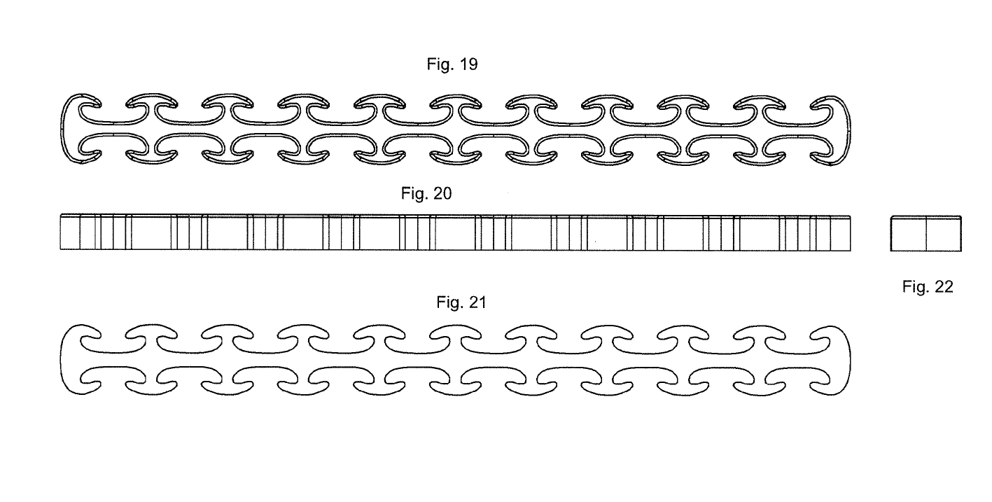

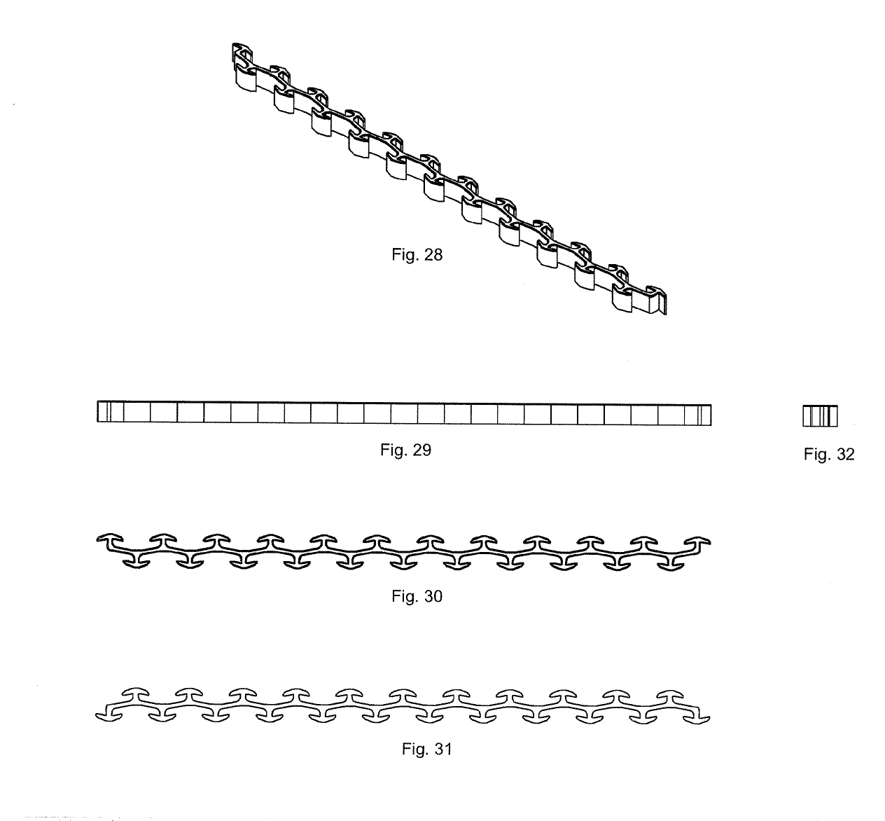

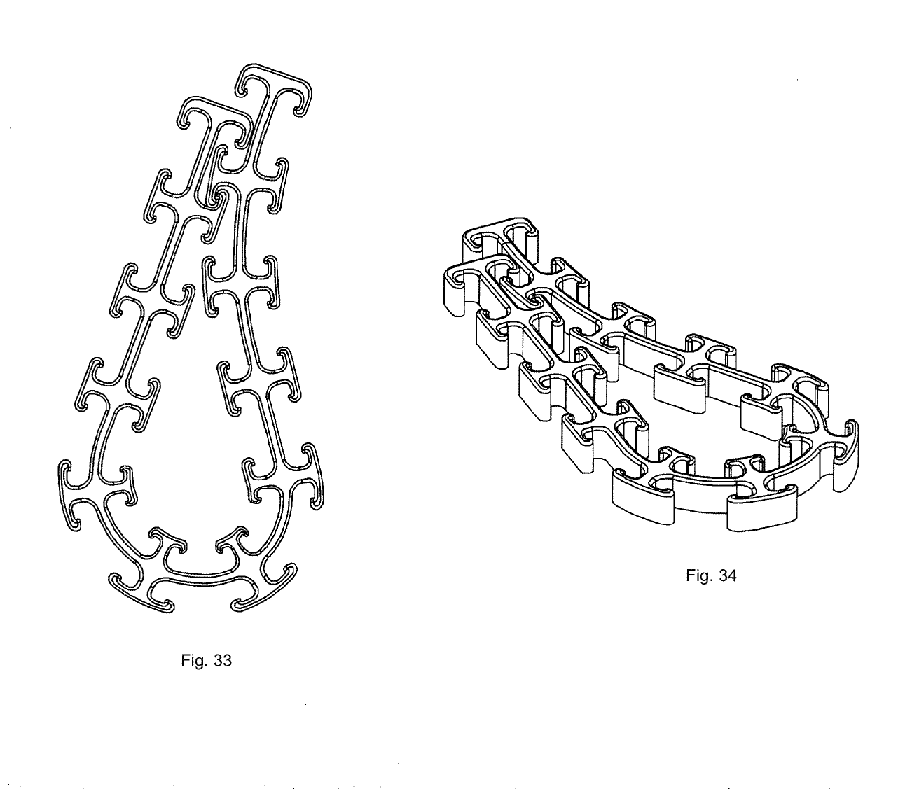

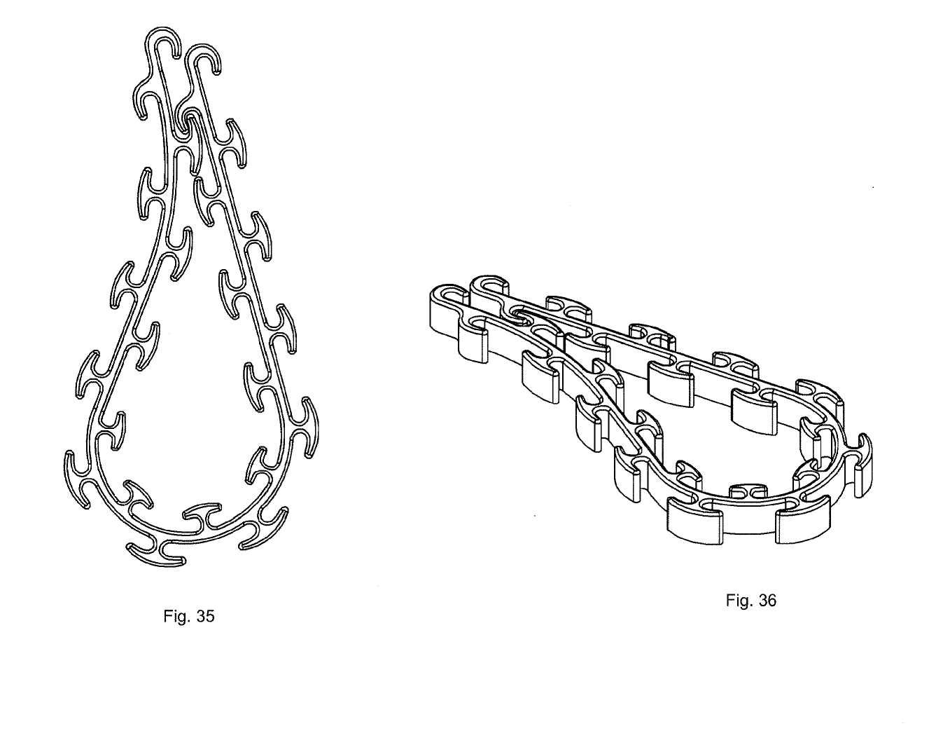

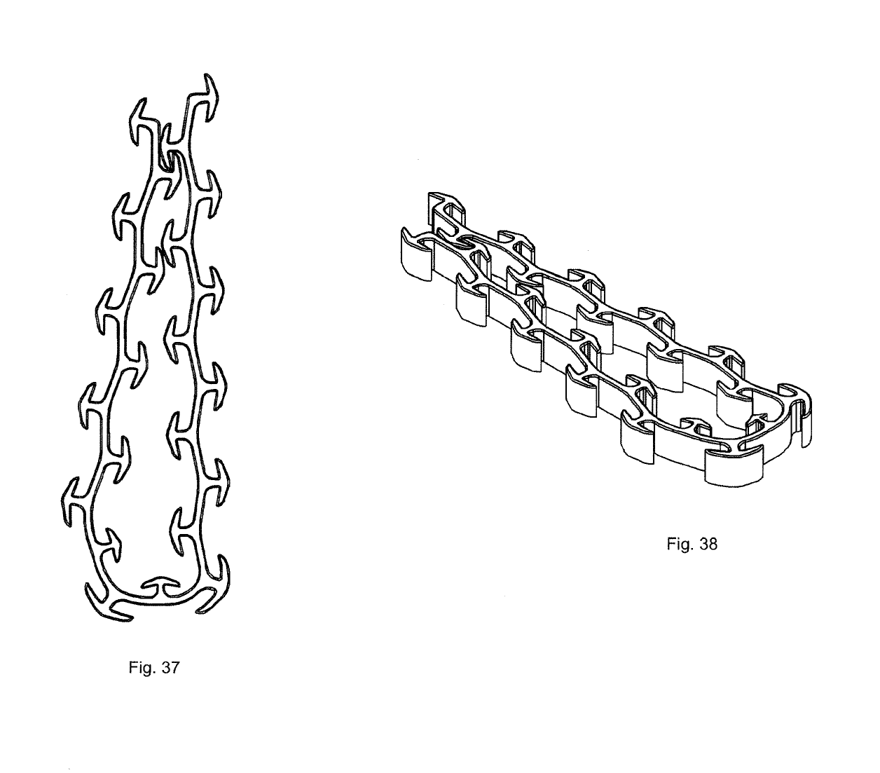

In the embodiments of the invention depicted in FIGS. 13-41, support 10 may be alternately designated support 10′, 10″, 10′″, and the like. Likewise, spine 12 may assume alternate numerical designations in FIGS. 13-41. Spine 12 in FIGS. 13, 18 and 23 is straight in its axial dimension, just like spine 12 of FIGS. 1-12. However, the spine as illustrated in FIG. 28 is somewhat non-linear in this dimension, and possesses an alternating “zig-zag” axial dimension. Both embodiments are functional and contemplated within the scope of the present invention.

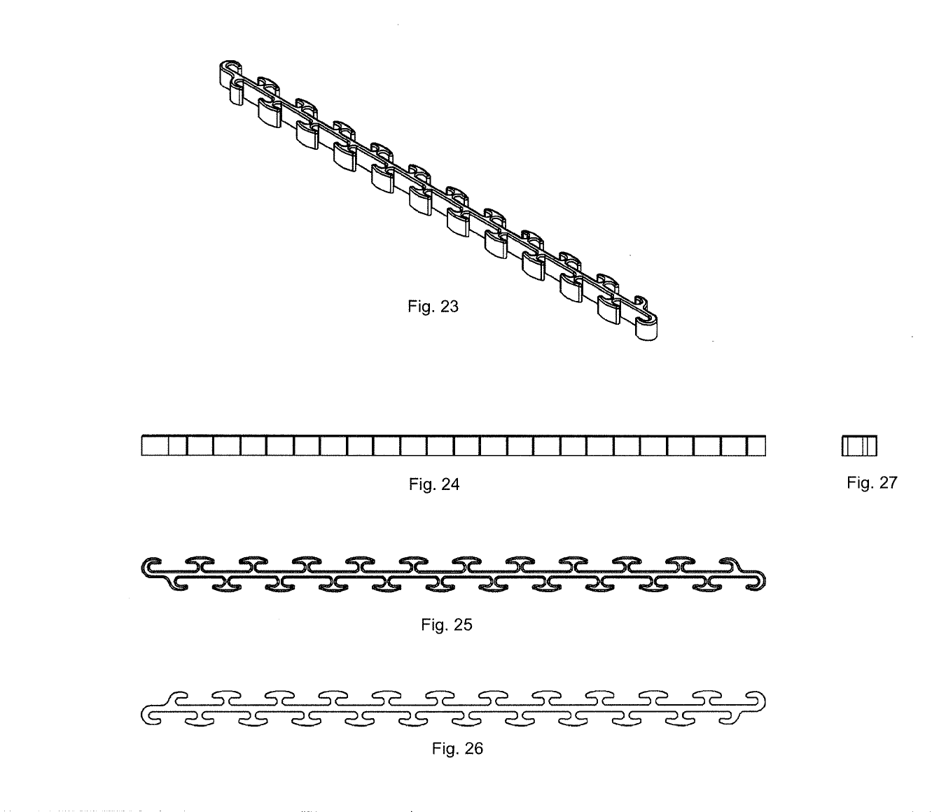

Likewise, the support of FIGS. 23 and 28 includes a singular element that may correspond in function to the end element 16 of the embodiment of FIGS. 1-12. Thus and as illustrated in FIGS. 34-40, the projections or elements at the end of the respective spines of the supports, may join in to engage an opposite side of the support, for example, to form a stable circular arrangement. The invention is submitted to comprehend and include all such geometric dispositions within its spirit and scope.

A plurality of heat resistant elements 14 extend outwardly from the elongate spine 12 and, in the exemplary embodiment, the heat resistant elements are grouped in oppositely disposed pairs of heat resistant elements 14 that extend the full length of the elongated spine 12 as well as two end heat resistant elements 16 that extend axially outwardly at each end of the support 10.

In the exemplary embodiment of FIGS. 1-4, the heat resistant elements 14 as illustrated are configured so as to extend outwardly in opposite directions; that is, some of the heat resistant elements 14 are directed at an acute angle A with respect to the spine 12 toward one end of heat resistant element 16, while other elements 14 extend at an acute angle B with respect to the spine 12 toward the opposite end of heat resistant element 16. As will later become clear, the spacing C between adjacent heat resistant elements 14 is also preferably controlled, and such spacing may be equal to or just slightly less that the width of the end heat resistant elements 16.

Again, as shown in the embodiment of FIG. 1, the heat resistant elements 14 can be comprised of silicone and molded in a unitary mold along with the elongated spine 12. As illustrated herein, the heat resistant elements 14 and end heat resistant elements 16 can be molded in the shape of leaves in order to present an aesthetically pleasing appearance such that the complete support 10 can have the appearance of a laurel. Of course, it will be appreciated that other shapes of heat resistant elements can be used consistent with the intent and purpose of the present invention.

As another feature, the heat resistant elements 14 and end heat resistant elements 16 can be hollow with large openings 18 in their upper surfaces and smaller openings 20 in their lower surfaces. Alternatively, the heat resistant elements 14 and end heat resistant elements 16 may be molded as solid components.

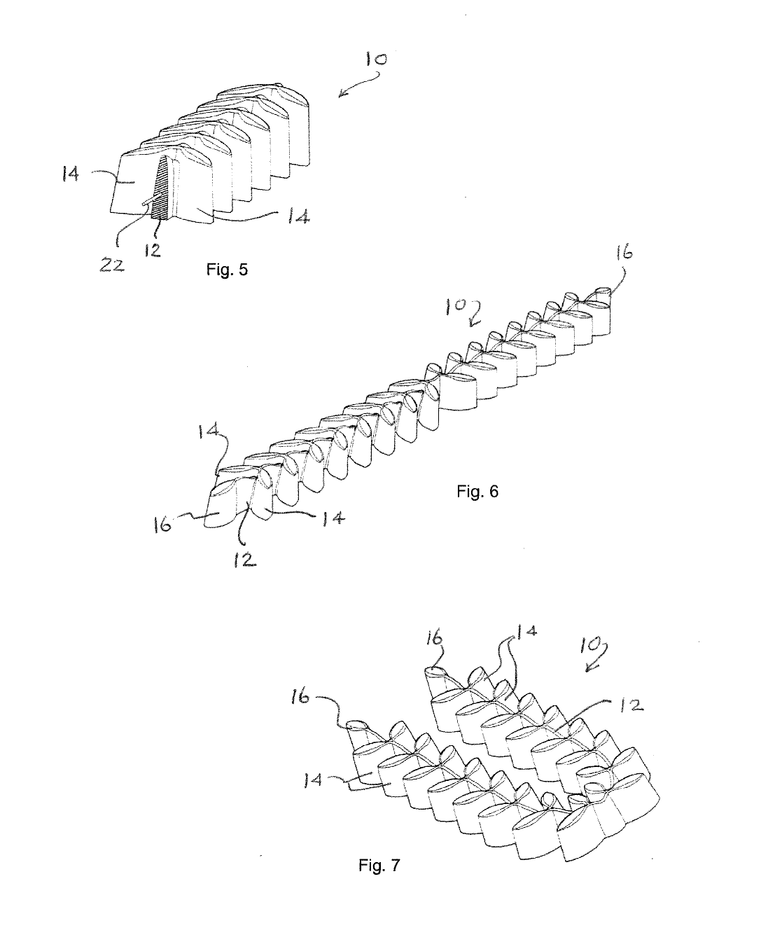

Referring now to FIG. 5, there is shown a perspective, cross sectional view of the support 10 of the present invention. Thus, there can be seen a core member 22 that is molded into the elongated spine 12. The core member 22 is a bendable material, such as a wire, but can be other materials, where the support 10 can be bent into a desired position. The core member 22 allows the support 10 to remain in the shape that has been manually manipulated by the user.

In the exemplary embodiment, the core member 22 can be molded into the elongated spine 12 in the molding process that produces the support 10 such that the support 10 is a unitary molded product.

Referring now to FIGS. 6 and 7, there are shown, respectively, perspective views of the support 10 of the present invention in a straight configuration, and in a U-shaped configuration. In the practice of the present invention, the straight configuration of FIG. 6 may be manually manipulated by a user to take on the U-shaped configuration of FIG. 7.

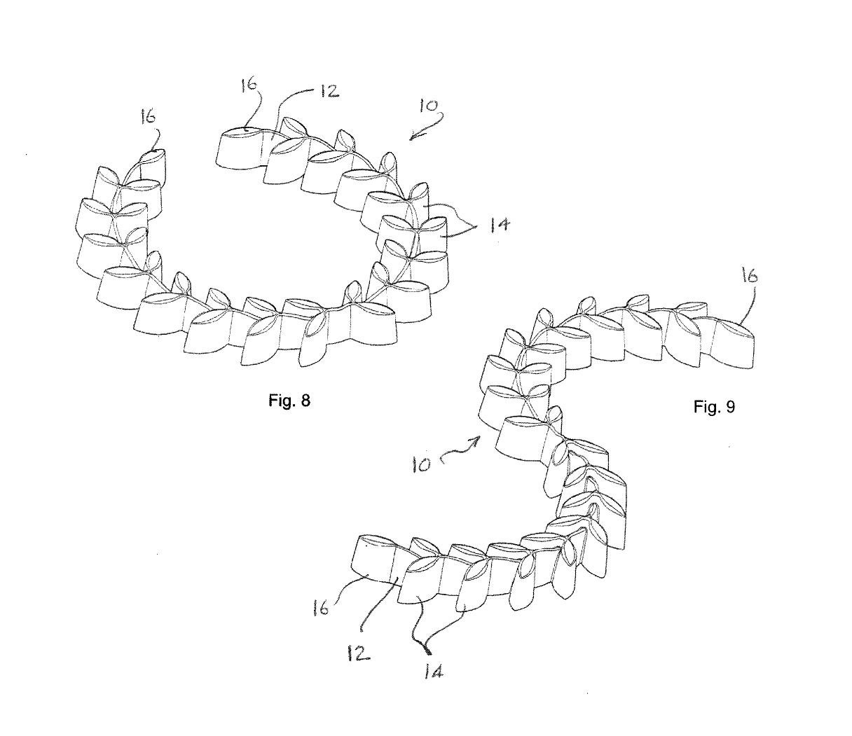

Other configurations that may be formed are shown in FIGS. 8 and 9 where the support 10 is shaped into a circular configuration (FIG. 8) and an S-shaped configuration (FIG. 9). Likewise alternate supports are shown in FIGS. 13-41, as to their configurations and assembly into a useable support in a roasting pan.

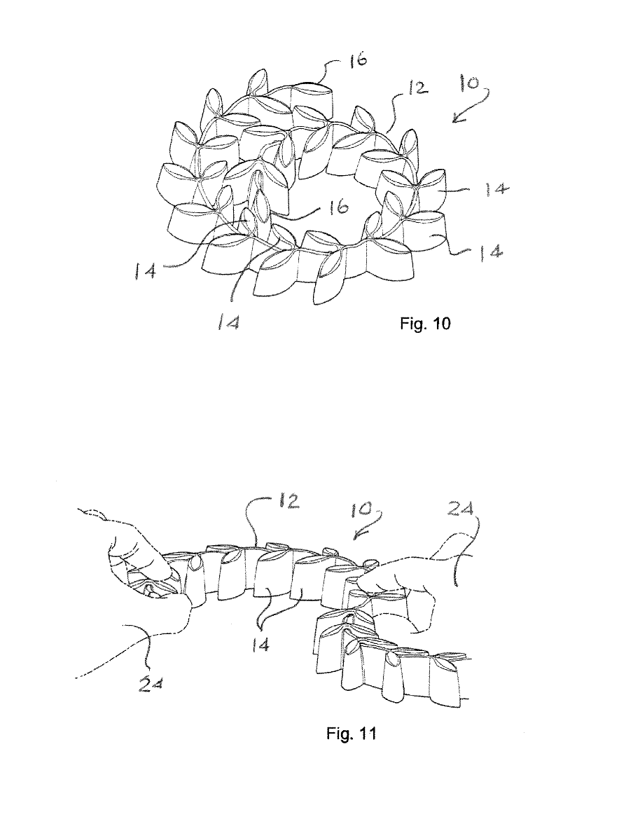

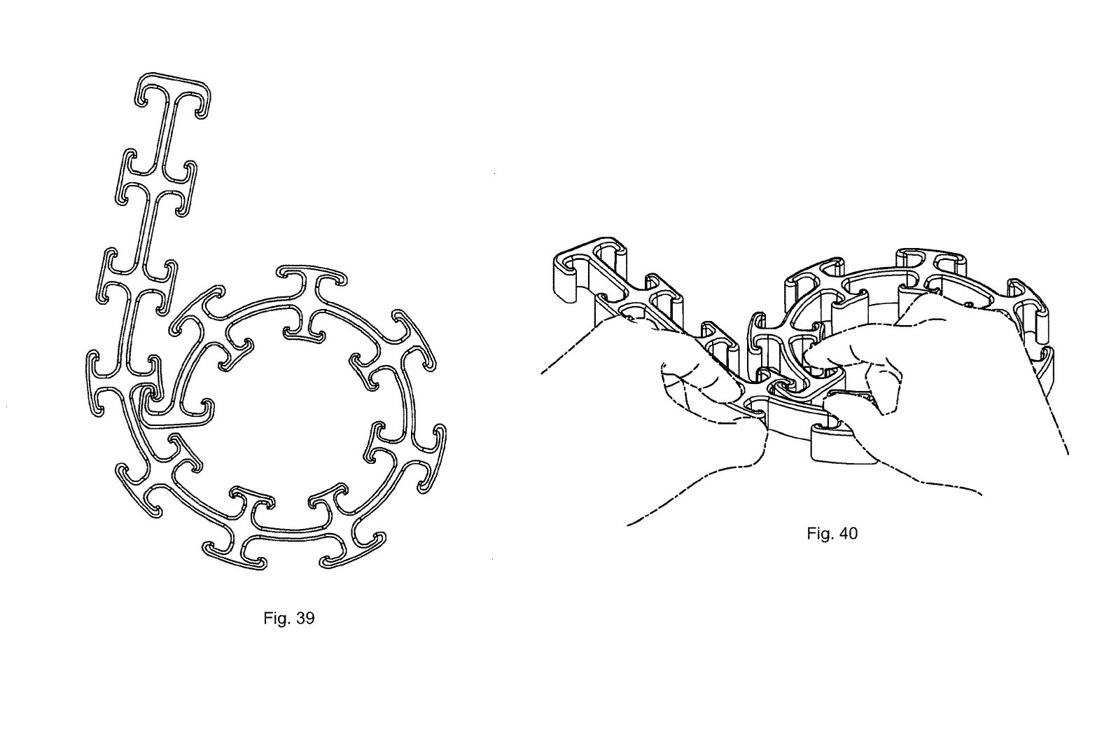

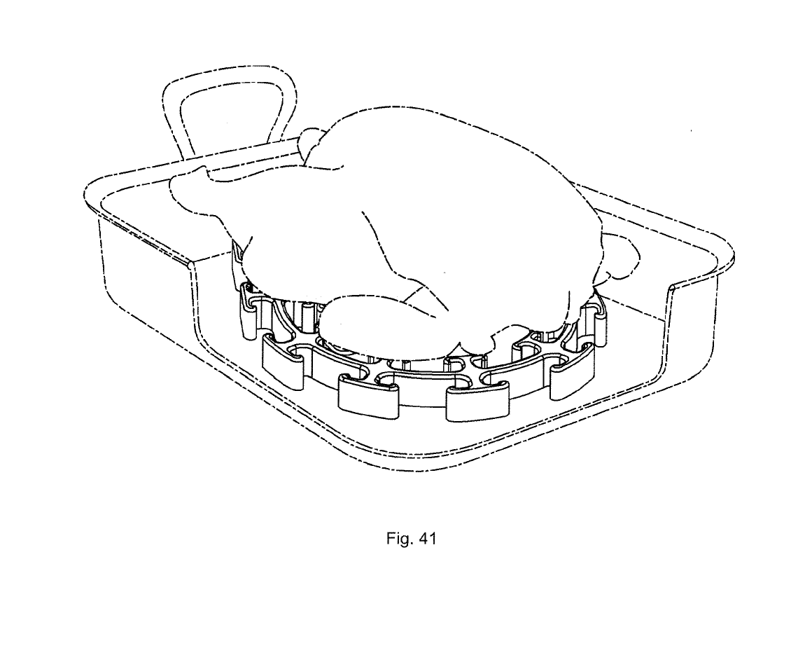

Referring now to FIG. 10 and to corresponding FIGS. 39 and 40, there is shown another feature of the present invention in that the support 10 has been manipulated into a circular shape and connected to itself. In this embodiment, an end heat resistant element 16 has been manipulated and can be inserted intermediate two adjacent heat resistant elements 14 in a ‘snap fit’-like engagement therebetween. As such, rather than have an end heat resistant element 14 simply at a distally isolated location, it can be connected to itself, such as by a ‘snap fit’ engagement at a selected location of adjacent heat resistant elements 14, to form a closed geometric configuration.

Referring now to FIG. 11, there is shown a support 10 in the process of being manipulated by the hands 24 of a user and, as can be seen, the user can change the shape of the support 10 by manipulating the support 10 to create a particular shape of support that is desired for use with a particular size or shape of food product that is being roasted.

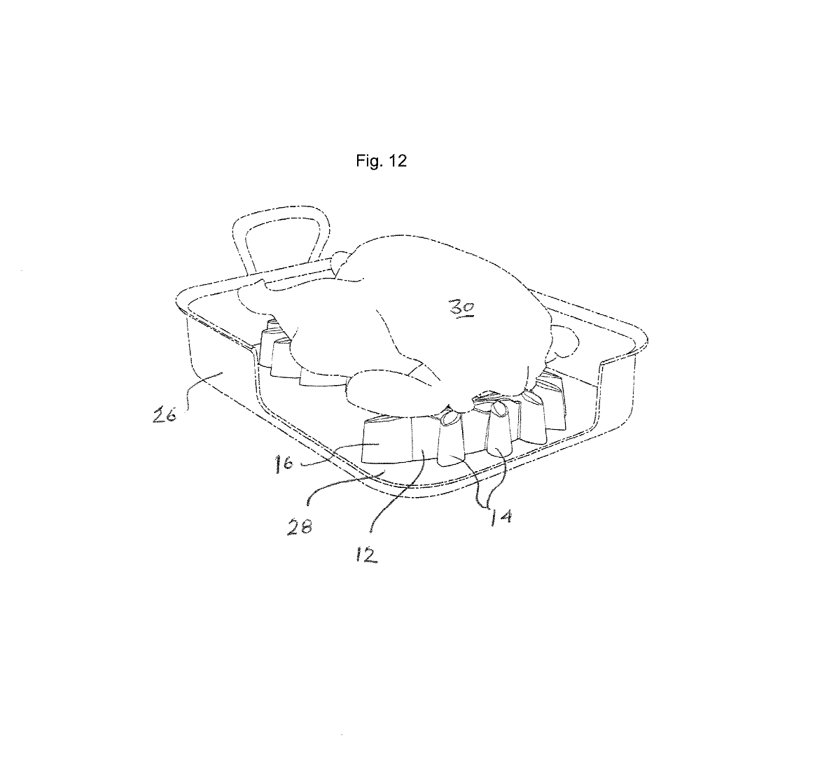

Referring finally to FIGS. 12 and 41, there is shown a perspective view, partially cut away, of a roasting pan 26 having a bottom 28 and having a food product 30 resting in the roasting pan 26. The food product 30 as shown is a turkey, however, as described, the versatility of the present support 10 (and support 10′ in FIG. 41) allows the support to be manipulated into any particular desired configuration so as to be applicable for supporting a wide variety of foods to be roasted.

Thus, in FIGS. 12 and 41, respectively, the food product 30 is held in a stable position elevated and out of contact with the bottom 28 of the roasting pan 26, so that it is not cooking in the accumulated fat and burned bits of food that will collect on bottom 28 during the cooking process. The particular configuration of the support 10 is therefore specially adapted by manipulation by the user to provide a solid resting base for food product 30, so as to create a uniform cooking environment for food product 30.

Those skilled in the art will readily recognize numerous adaptations and modifications which can be made to the flexible support and use thereof of the present invention which will result in an improved support, yet all of which will fall within the scope and spirit of the present invention as defined in the following claims Accordingly, the invention is to be limited only by the following claims and their equivalents.

What is claimed is:

1. A support for supporting a food during roasting thereof, the support comprising a pliable elongated spine comprised of a heat resistant material, and a plurality of heat resistant elements molded to and extending outwardly from the elongated spine, wherein the support can be manipulated to a desired shape for supporting foods having differing shapes and sizes.

2. The support as defined in claim 1 wherein said heat resistant elements are leaf shaped so as to provide an overall appearance of a support as a laurel.

3. The support as defined in claim 1 wherein said heat resistant elements comprise projections extending laterally outward from said spine.

4. The support as defined in claim 3 wherein said heat resistant elements define at least one projection on the free ends thereof, said projection capable of releasable engagement with other of said heat resistant elements.

5. The support as defined in claim 4 wherein said heat resistant elements define two projections on the said free ends thereof.

6. The support as defined in claim 1 wherein said heat resistant elements are disposed in regularly spaced relation to each other on both sides of said spine.

7. The support as defined in claim 6 wherein said heat resistant elements are radially aligned with each other along said spine.

8. The support as defined in claim 1 wherein said spine is linear in its axial dimension.

9. The support as defined in claim 1 wherein said spine is non-linear in its axial dimension.

10. The support as defined in claim 9 wherein said spine defines a regular alternation in its non-linear axial dimension.

11. The support as defined in claim 1 wherein said support includes a bendable core member molded within said spine.

12. The support as defined in claim 11 wherein the core member is a wire.

13. The support as defined in claim 12 wherein the wire is molded into and extends at least substantially the full length of the pliable spine.

14. The support as defined in claim 1 wherein the elongated spine and the heat resistant members are comprised of silicone.

15. The support as defined in claim 1 wherein the support has an end heat resistant element that can be joined by a snap fit between two adjacent heat resistant elements.

16. The support as defined in claim 1 wherein the heat resistant elements are grouped in pairs oppositely extending outwardly from the pliable spine.

17. The support as defined in claim 16 wherein each pair of heat resistant elements extends from the pliable spine at an acute angle with respect to the pliable spine.

18. The support as defined in claim 1 wherein the heat resistant elements are hollow.

19. A method of supporting a food for roasted within a roasting pan having a bottom surface, the method comprising the steps of:
providing a support having a pliable elongated spine comprised of a heat resistant material, a bendable core member molded within the elongated spine and a plurality of heat resistant elements molded to and extending outwardly from the elongated spine,
manually manipulating the support to form a shape that supports the food in a position vertically spaced above the bottom surface of the roasting pan; and
placing the food atop of the formed structure for roasting the food.
